(19) United States
(12) Patent Application Publication
(10) Pub. No.: US 2026/0360303 A1
(43) Pub. Date: Nov. 12, 2026

(54) SWEEP CIRCUIT, DISPLAY DEVICE AND ELECTRONIC DEVICE

(71) Applicants: Samsung Display Co., LTD., Yongin-si (KR); SEOUL NATIONAL UNIVERSITY R&DB FOUNDATION, Seoul (KR)

(72) Inventors: SEHYUN LEE, Yongin-si (KR); Saeru Cheon, Seoul (KR); Soo-Yeon Lee, Seoul (KR); KYUNGHOON CHUNG, Yongin-si (KR); KWIHYUN KIM, Yongin-si (KR)

(21) Appl. No.: 19/398,244

(22) Filed: Nov. 24, 2025

(30) Foreign Application Priority Data
May 12, 2025 (KR) 10-2025-0061245

(51) Int. Cl. G09G 3/32; G09G 3/3266; G09G 3/3291

(52) U.S. Cl. CPC G09G 3/32; G09G 3/3266; G09G 3/3291; G09G 2300/043; G09G 2300/0819; G09G 2310/0267; G09G 2310/0275; G09G 2310/08; G09G 2320/064

(57) ABSTRACT

A sweep circuit includes a driving transistor, a capacitor connected between a power supply voltage line and a gate of the driving transistor, a first transistor which applies a first reset voltage to a load capacitor connected to a sweep line, a second transistor which applies a second reset voltage to the capacitor, a third transistor which transfers a sweep data voltage to a first terminal of the driving transistor, a fourth transistor which connects the gate and a second terminal of the driving transistor to each other, a fifth transistor which connects the first terminal of the driving transistor to the power supply voltage line, and a sixth transistor which connect the second terminal of the driving transistor to the sweep line.

This application claims priority to Korean Patent Application No. 10-2025-0061245, filed on May. 12, 2025, and all the benefits accruing therefrom under 35 U.S.C. §119, the content of which in its entirety is herein incorporated by reference.

### 1. FIELD

Embodiments of the present disclosure relate to a display device, and more particularly to a sweep circuit that generates a sweep signal, a display device including the sweep circuit, and an electronic device including the display device.

### 2. DESCRIPTION OF THE RELATED ART

A display device may display an image by driving a light-emitting element, such as a micro-light-emitting diode (“micro-LED”) or an organic light-emitting diode (“OLED”), according to a pulse amplitude modulation (“PAM”) method or a pulse width modulation (“PWM”) method, for example. In the PAM method, a gray level may be represented by adjusting an amount (or an amplitude) of an emission current provided to the light-emitting element. In the PWM method, the gray level may be represented by adjusting a time period (or a pulse width) during which the emission current is provided to the light-emitting element.

### SUMMARY

In a display device, a wavelength of light emitted by a light-emitting element such as a micro-light-emitting diode (“micro-LED”) may be shifted according to the amount of an emission current. Thus, in a case where the light-emitting element such as the micro-LED is driven in a pulse width modulation (“PAM”) method, for example, a color shift phenomenon may occur, and the image may be distorted.

Some embodiments provide a sweep circuit that generates a sweep signal for driving a light-emitting element in a PWM method.

Some embodiments provide a display device including the sweep circuit.

Some embodiments provide an electronic device including the display device.

According to embodiments, a sweep circuit includes a driving transistor including a gate, a first terminal and a second terminal, a capacitor including a first electrode connected to a power supply voltage line, and a second electrode connected to the gate of the driving transistor, a first transistor which applies a first reset voltage to a load capacitor connected to a sweep line in response to a first signal, a second transistor which applies a second reset voltage to the second electrode of the capacitor in response to the first signal, a third transistor which transfers a sweep data voltage to the first terminal of the driving transistor in response to a second signal, a fourth transistor which connects the gate and the second terminal of the driving transistor to each other in response to a third signal, a fifth transistor which connect the first terminal of the driving transistor to the power supply voltage line in response to an emission signal, and a sixth transistor which connects the second terminal of the driving transistor to the sweep line in response to the emission signal.

In embodiments, in a threshold compensation period of a frame period, the fourth transistor may diode-connect the driving transistor, and the capacitor may store a voltage in which a threshold voltage of the driving transistor is compensated through the diode-connected driving transistor.

In embodiments, in a sweep period of a frame period, the driving transistor may continuously supply a current to the load capacitor to apply a sweep signal which gradually changes to the sweep line.

In embodiments, the driving transistor, the first transistor, the second transistor, the third transistor, the fourth transistor, the fifth transistor and the sixth transistor may be P-type transistors.

In embodiments, the first transistor may include a gate which receives the first signal, a first terminal connected to the load capacitor, and a second terminal which receives the first reset voltage, the second transistor may include a gate which receives the first signal, a first terminal connected to the second electrode of the capacitor, and a second terminal which receives the second reset voltage, the third transistor may include a gate which receives the second signal, a first terminal connected to a sweep data line through which the sweep data voltage is transferred, and a second terminal connected to the first terminal of the driving transistor, the fourth transistor may include a gate which receives the third signal, a first terminal connected to the second terminal of the driving transistor, and a second terminal connected to the gate of the driving transistor, the fifth transistor may include a gate which receives the emission signal, a first terminal connected to the power supply voltage line, and a second terminal connected to the first terminal of the driving transistor, and the sixth transistor may include a gate which receives the emission signal, a first terminal connected to the second terminal of the driving transistor, and a second terminal connected to the sweep line.

In embodiments, the sweep circuit may provide a sweep signal to an N-th pixel row among a plurality of pixel rows of a display panel through the sweep line, where N is an integer greater than or equal to 2, the first signal may be a scan signal for an (N-1)-th pixel row, and the second signal and the third signal may be a same scan signal as a scan signal for the N-th pixel row.

In embodiments, a frame period of a display device including the sweep circuit may include an initialization period in which the capacitor and the load capacitor are initialized, a threshold compensation period in which the capacitor stores a voltage in which a threshold voltage of the driving transistor is compensated, and a sweep period a sweep signal applied to the sweep line gradually changes.

In embodiments, in the initialization period, the first signal may have an on-level, the second signal, the third signal and the emission signal may have an off-level, the first and second transistors may be turned on in response to the first signal having the on-level, the load capacitor may be initialized based on the first reset voltage applied thereto through the first transistor, and the capacitor may be initialized based on the second reset voltage applied thereto through the second transistor.

In embodiments, in the threshold compensation period, the first signal and the emission signal may have an off-level, the second signal and the third signal may have an on-level, the third transistor may be turned on in response to the second signal having the on-level and may apply the sweep data voltage to the first terminal of the driving transistor, the fourth transistor may be turned on in response to the third signal having the on-level and may diode-connect the driving transistor, and the capacitor may store, between the first and second electrodes of the capacitor, a voltage obtained by subtracting the sweep data voltage from a power supply voltage of the power supply voltage line and adding an absolute value of the threshold voltage of the driving transistor.

In embodiments, in the sweep period, the first signal, the second signal, and the third signal may have an off-level, the emission signal may have an on-level, the driving transistor may continuously supply a current corresponding to a voltage difference between a power supply voltage of the power supply voltage line and the sweep data voltage to the load capacitor, and the sweep signal that gradually changes may be applied to the sweep line.

In embodiments, the sweep circuit may further include a seventh transistor which applies a compensation data voltage higher than the sweep data voltage to the first terminal of the driving transistor in response to a fourth signal.

In embodiments, the compensation data voltage may be generated by adding a reference voltage to the sweep data voltage.

In embodiments, in an additional compensation period of a frame period, a voltage of the gate of the driving transistor may be increased by a product of the reference voltage and a compensation coefficient, and the compensation coefficient may be determined based on at least one selected from a subthreshold swing and a mobility of the driving transistor.

In embodiments, the seventh transistor may include a gate which receives the fourth signal, a first terminal connected to a compensation data line, and a second terminal connected to the first terminal of the driving transistor.

In embodiments, the sweep circuit may provide a sweep signal to an N-th pixel row among a plurality of pixel rows of a display panel through the sweep line, where N is an integer greater than or equal to 2, the first signal may be a first scan signal for an (N-1)-th pixel row, the second signal may be a first scan signal for the N-th pixel row; the third signal may be a second scan signal different from the first scan signal for the N-th pixel row, and the fourth signal may be a third scan signal different from the first and second scan signals for the N-th pixel row.

In embodiments, a frame period of a display device including the sweep circuit may include an initialization period in which the capacitor and the load capacitor are initialized, a threshold compensation period in which the capacitor stores a voltage in which a threshold voltage of the driving transistor is compensated, an additional compensation period in which a voltage of the gate of the driving transistor is increased, and a sweep period in which a sweep signal applied to the sweep line gradually changes.

In embodiments, in the additional compensation period, the first signal, the second signal and the emission signal may have an off-level, the third signal and the fourth signal may have an on-level, the seventh transistor may be turned on in response to the fourth signal having the on-level and may apply the compensation data voltage corresponding to a sum of the sweep data voltage and a reference voltage to the first terminal of the driving transistor, the fourth transistor may be turned on in response to the third signal having the on-level and may diode-connect the driving transistor, and the voltage of the gate of the driving transistor may be increased by a product of the reference voltage and a compensation coefficient.

According to embodiments, a display device includes a display panel including a plurality of sweep lines and a plurality of pixels connected to the plurality of sweep lines, a sweep driver including a plurality of sweep circuits respectively connected to the plurality of sweep lines, a scan driver which provides a scan signal to each of the pixels, and provides a first signal, a second signal and a third signal to each of the plurality of sweep circuits, an emission driver which provides an emission signal to each of the plurality of pixels and each of the plurality of sweep circuits, a data driver which provides a pulse width modulation (PWM) data voltage and a constant current generation (CCG) data voltage to each of the plurality of pixels, and provides a sweep data voltage to each of the plurality of sweep circuits, and a controller which control the scan driver, the emission driver and the data driver. In such embodiments, each of the plurality of sweep circuits includes a driving transistor including a gate, a first terminal and a second terminal, a capacitor including a first electrode connected to a power supply voltage line, and a second electrode connected to the gate of the driving transistor, a first transistor which applies a first reset voltage to a load capacitor connected to a corresponding sweep line among the plurality of sweep lines in response to the first signal, a second transistor which applies a second reset voltage to the second electrode of the capacitor in response to the first signal, a third transistor which transfers the sweep data voltage to the first terminal of the driving transistor in response to the second signal, a fourth transistor which connects the gate and the second terminal of the driving transistor to each other in response to the third signal, a fifth transistor which connects the first terminal of the driving transistor to the power supply voltage line in response to the emission signal, and a sixth transistor which connects the second terminal of the driving transistor to the corresponding sweep line in response to the emission signal.

In embodiments, each of the plurality of pixels may include a PWM circuit which generates a PWM signal based on the PWM data voltage and a sweep signal applied thereto through the corresponding sweep line, a CCG circuit which generates an emission current based on the CCG data voltage and the PWM signal, and a light-emitting element which emits light based on the emission current.

According to embodiments, an electronic device includes a processor which provides input image data, a display device which receives the input image data from the processor, and displays an image based on the input image data. In such embodiments, the display device includes a display panel including a plurality of sweep lines and a plurality of pixels connected to the plurality of sweep lines, a sweep driver including a plurality of sweep circuits respectively connected to the plurality of sweep lines, a scan driver which provides a scan signal to each of the pixels, and provides a first signal, a second signal and a third signal to each of the plurality of sweep circuits, an emission driver which provides an emission signal to each of the plurality of pixels and each of the plurality of sweep circuits, a data driver which provides a pulse width modulation (PWM) data voltage and a constant current generation (CCG) data voltage to each of the plurality of pixels, and provides a sweep data voltage to each of the plurality of sweep circuits, and a controller which controls the scan driver, the emission driver and the data driver. In such embodiments, each of the plurality of sweep circuits includes a driving transistor including a gate, a first terminal and a second terminal, a capacitor including a first electrode connected to a power supply voltage line, and a second electrode connected to the gate of the driving transistor, a first transistor which applies a first reset voltage to a load capacitor connected to a corresponding sweep line among the plurality of sweep lines in response to the first signal, a second transistor which applies a second reset voltage to the second electrode of the capacitor in response to the first signal, a third transistor which transfers the sweep data voltage to the first terminal of the driving transistor in response to the second signal, a fourth transistor which connects the gate and the second terminal of the driving transistor to each other in response to the third signal, a fifth transistor which connects the first terminal of the driving transistor to the power supply voltage line in response to the emission signal, and a sixth transistor which connects the second terminal of the driving transistor to the corresponding sweep line in response to the emission signal.

In embodiments of the disclosure, as described above, the sweep circuit of a display device and an electronic device may provide a pixel row with a sweep signal that gradually changes (e.g., increases) through a sweep line by supplying a load capacitor connected to the sweep line with current using P-type transistors (e.g., P-type metal-oxide-semiconductor (“PMOS”) low temperature polycrystalline silicon (“LTPS”) thin film transistors (“TFTs”)).

In embodiments of the disclosure, in the sweep circuit of a display device and an electronic device, a threshold voltage, a subthreshold swing and/or a mobility of a driving transistor in the sweep circuit may be compensated, and thus the sweep circuit may accurately generate the desired sweep signal.

### BRIEF DESCRIPTION OF THE DRAWINGS

Illustrative, non-limiting embodiments will be more clearly understood from the following detailed description in conjunction with the accompanying drawings.

FIG. 1 is a circuit diagram illustrating a sweep circuit according to embodiments.

FIG. 2 is a signal timing diagram for describing an example of an operation of a sweep circuit according to embodiments.

FIG. 3 is a circuit diagram for describing an example of an operation of a sweep circuit of FIG. 1 in an initialization period.

FIG. 4 is a circuit diagram for describing an example of an operation of a sweep circuit of FIG. 1 in a threshold compensation period.

FIG. 5 is a circuit diagram for describing an example of an operation of a sweep circuit of FIG. 1 in a sweep period.

FIG. 6 is a diagram illustrating an example of sweep signals according to sweep data voltages.

FIG. 7A is a diagram illustrating an example of sweep signals in a sweep period, and FIG. 7B is a diagram illustrating an example of error rates of the sweep signals of FIG. 7A.

FIG. 8 is a circuit diagram illustrating a sweep circuit according to embodiments.

FIG. 9 is a signal timing diagram for describing an example of an operation of a sweep circuit according to embodiments.

FIG. 10 is a circuit diagram for describing an example of an operation of a sweep circuit of FIG. 8 in an initialization period.

FIG. 11 is a circuit diagram for describing an example of an operation of a sweep circuit of FIG. 8 in a threshold compensation period.

FIG. 12 is a circuit diagram for describing an example of an operation of a sweep circuit of FIG. 8 in an additional compensation period.

FIG. 13 is a circuit diagram for describing an example of an operation of a sweep circuit of FIG. 8 in a sweep period.

FIG. 14A is a diagram illustrating an example of sweep signals in a sweep period, and FIG. 14B is a diagram illustrating an example of error rates of the sweep signals of FIG. 14A.

FIG. 15A is a diagram illustrating another example of sweep signals in a sweep period, and FIG. 15B is a diagram illustrating an example of error rates of the sweep signals of FIG. 15A.

FIG. 16 is a block diagram illustrating a display device according to embodiments.

FIG. 17 is a diagram illustrating an example of a pixel included in a display device according to embodiments.

FIG. 18 is a block diagram illustrating an electronic device according to embodiments.

FIG. 19 is a schematic diagram illustrating electronic devices according to various embodiments.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, "a", "an," "the," and “at least one” do not denote a limitation of quantity, and are intended to include both the singular and plural, unless the context clearly indicates otherwise. Thus, reference to “an” element in a claim followed by reference to “the” element is inclusive of one element and a plurality of the elements. For example, "an element" has the same meaning as “at least one element," unless the context clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The terms “below” or “beneath” can, therefore, encompass both an orientation of above and below.

"About" or "approximately" as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, "about" can mean within one or more standard deviations, or within ± 30%, 20%, 10% or 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Hereinafter, embodiments of the invention will be explained in detail with reference to the accompanying drawings. The same reference numerals may be used for the same components in the drawings, and any repetitive detailed descriptions of the same components may be omitted or simplified.

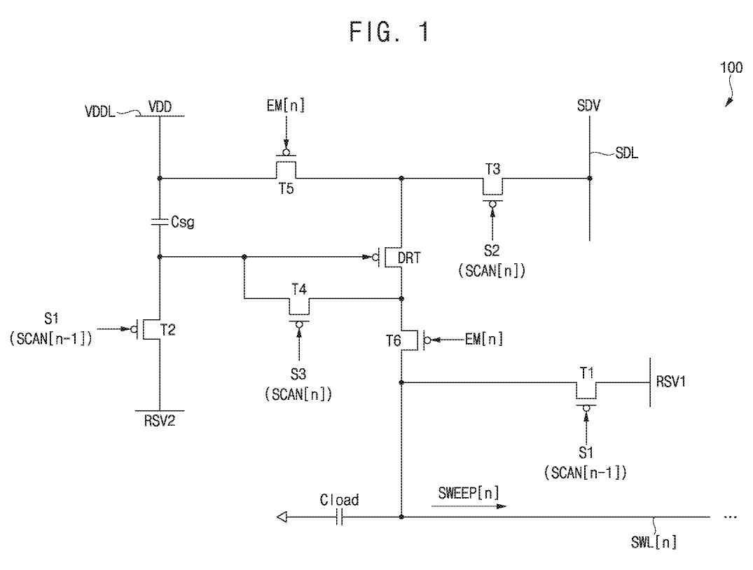

FIG. 1 is a circuit diagram illustrating a sweep circuit according to embodiments.

Referring to FIG. 1, a sweep circuit 100 according to embodiments may provide a sweep signal SWEEP[n] to a corresponding pixel row among a plurality of pixel rows of a display panel through a sweep line SWL[n]. In some embodiments, the sweep circuit 100 may include a driving transistor DRT, a capacitor Csg, a first transistor T1, a second transistor T2, a third transistor T3, a fourth transistor T4, a fifth transistor T5 and a sixth transistor T6.

The driving transistor DRT may generate the sweep signal SWEEP[n] by supplying a current to a load capacitor Cload connected to the sweep line SWL[n]. In an embodiment, for example, during a sweep period, the driving transistor DRT may generate a current based on a voltage stored in the capacitor Csg, and may continuously supply the current to the load capacitor Cload to apply the sweep signal SWEEP[n] that gradually changes (e.g., increases) to the sweep line SWL[n]. In some embodiments, as illustrated in FIG. 1, the load capacitor Cload may include a first electrode connected to the sweep line SWL[n], the first transistor T1 and the sixth transistor T6, and a second electrode which receives a ground voltage. In some embodiments, the load capacitor Cload may be implemented as a separate component connected to the sweep line SWL[n]. In other embodiments, the load capacitor Cload may be implemented as a parasitic capacitor of the sweep line SWL[n]. Further, in some embodiments, the driving transistor DRT may include a gate connected to the capacitor Csg, the second transistor T2 and the fourth transistor T4, a first terminal (e.g., a source) connected to the third transistor T3 and the fifth transistor T5, and a second terminal (e.g., a drain) connected to the fourth transistor T4 and the sixth transistor T6.

The capacitor Csg may be connected between a power supply voltage line VDDL and the gate of the driving transistor DRT. In an embodiment, for example, in a threshold compensation period, the capacitor Csg may store a voltage in which a threshold voltage of the driving transistor DRT is compensated. In some embodiments, the capacitor Csg may be connected to the source and the gate of the driving transistor DRT during the sweep period, and thus may be referred to as a source-gate capacitor. Further, in some embodiments, the capacitor Csg may include a first electrode connected to the power supply voltage line VDDL which transfers a power supply voltage VDD, and a second electrode connected to the gate of the driving transistor DRT.

The first transistor T1 may apply a first reset voltage RSV1 to the load capacitor Cload connected to the sweep line SWL[n] in response to a first signal S1. The first transistor T1 may be referred to as a first reset transistor for resetting or initializing the load capacitor Cload. In some embodiments, in a case where the sweep circuit 100 provides the sweep signal SWEEP[n] to an N-th pixel row among the plurality of pixel rows of the display panel, where N is an integer greater than or equal to 2, the first signal S1 applied to the sweep circuit 100 may be a scan signal SCAN[n-1] for an (N-1)-th pixel row immediately preceding the N-th pixel row. Further, in some embodiments, the first transistor T1 may include a gate which receives the first signal S1, a first terminal connected to the load capacitor Cload, and a second terminal which receives the first reset voltage RSV1.

The second transistor T2 may apply a second reset voltage RSV2 to the second electrode of the capacitor Csg in response to the first signal S1. The second transistor T2 may be referred to as a second reset transistor for resetting or initializing the capacitor Csg. In some embodiments, the second reset voltage RSV2 may be different from the first reset voltage RSV1. In an embodiment, for example, the first reset voltage RSV1 may be, but is not limited to, about 5 volts (V), and the second reset voltage RSV2 may be, but is not limited to, about -12 V. Further, in some embodiments, the second transistor T2 may include a gate which receives the first signal S1, a first terminal connected to the second electrode of the capacitor Csg, and a second terminal which receives the second reset voltage RSV2.

The third transistor T3 may transfer a sweep data voltage SDV to the first terminal of the driving transistor DRT in response to a second signal S2. The third transistor T3 may be referred to as a scan transistor for transferring the sweep data voltage SDV. In some embodiments, in the case where the sweep circuit 100 provides the sweep signal SWEEP[n] to the N-th pixel row through the sweep line SWL[n], the second signal S2 applied to the sweep circuit 100 may be a scan signal SCAN[n] for the N-th pixel row. Further, in some embodiments, the third transistor T3 may include a gate which receives the second signal S2, a first terminal connected to a sweep data line SDL, and a second terminal connected to the first terminal of the driving transistor DRT.

The fourth transistor T4 may connect the gate and the second terminal of the driving transistor DRT to each other in response to a third signal S3, thereby diode-connecting the driving transistor DRT. The fourth transistor T4 may be referred to as a compensation transistor for compensating the threshold voltage of the driving transistor DRT. In some embodiments, in the case where the sweep circuit 100 provides the sweep signal SWEEP[n] to the N-th pixel row through the sweep line SWL[n], the third signal S3 applied to the sweep circuit 100 may be substantially the same as the second signal S2, or the scan signal SCAN[n] for the N-th pixel row. Thus, during a threshold compensation period in which the scan signal SCAN[n] has an on-level, the third transistor T3 may transfer the sweep data voltage SDV to the first terminal (e.g., the source) of the driving transistor DRT, the fourth transistor T4 may diode-connect the driving transistor DRT, and the capacitor Csg may store the voltage in which the threshold voltage of the driving transistor DRT is compensated through the diode-connected driving transistor DRT. Further, in some embodiments, the fourth transistor T4 may include a gate which receives the third signal S3, a first terminal connected to the second terminal of the driving transistor DRT, and a second terminal connected to the gate of the driving transistor DRT.

The fifth transistor T5 may connect the first terminal of the driving transistor DRT to the power supply voltage line VDDL in response to an emission signal EM[n], and the sixth transistor T6 may connect the second terminal of the driving transistor DRT to the sweep line SWL[n] in response to the emission signal EM[n]. The fifth and sixth transistors T5, T6 may form a path for the current generated by the driving transistor DRT from the power supply voltage line VDDL to the load capacitor Cload. In some embodiments, the fifth transistor T5 may include a gate which receives the emission signal EM[n], a first terminal connected to the power supply voltage line VDDL, and a second terminal connected to the first terminal of the driving transistor DRT, and the sixth transistor T6 may include a gate which receives the emission signal EM[n], a first terminal connected to the second terminal of the driving transistor DRT, and a second terminal connected to the sweep line SWL[n] and the load capacitor Cload.

In some embodiments, as illustrated in FIG. 1, the driving transistor DRT, the first transistor T1, the second transistor T2, the third transistor T3, the fourth transistor T4, the fifth transistor T5 and the sixth transistor T6 may be P-type transistors. In an embodiment, for example, all transistors DRT and T1 through T6 included in the sweep circuit 100 may be, but are not limited to, P-type low temperature polycrystalline silicon (“LTPS”) transistors or P-type metal-oxide-semiconductor (“PMOS”) LTPS thin film transistors (“TFTs”). In a case where each pixel drives a micro-light-emitting diode (“micro-LED”) in a pulse width modulation (“PWM”) method, the pixel may include P-type LTPS transistors having higher mobility and generating higher current than N-type amorphous indium-gallium-zinc-oxide (a-IGZO) transistors. Thus, in a display device in which each pixel includes the micro-LED, in the case where all transistors DRT and T1 through T6 of the sweep circuit 100 are the P-type LTPS transistors, all transistors DRT and T1 through T6 of the sweep circuit 100 may be formed by a process substantially the same as a process for forming the P-type LTPS transistors of the plurality of pixels. Accordingly, compared with a display device in which each sweep circuit includes N-type a-IGZO transistors, the display device including the sweep circuit 100 with the P-type LTPS transistors according to embodiments may have a reduced manufacturing cost and a relatively narrow bezel.

As described above, the sweep circuit 100 according to embodiments may provide the sweep signal SWEEP[n] that gradually changes (e.g., increases) to the corresponding pixel row through the sweep line SWL[n] by providing the current to the load capacitor Cload connected to the sweep line SWL[n] using the transistors DRT and T1 through T6 implemented with the P-type transistors (e.g., PMOS LTPS TFTs). Further, in the sweep circuit 100 according to embodiments, the fourth transistor T4 may diode-connect the driving transistor DRT, and thus the threshold voltage of the driving transistor DRT may be compensated in a diode-connection method. Thus, the sweep circuit 100 according to embodiments may accurately generate the desired sweep signal SWEEP[n].

Hereinafter, an operation of the sweep circuit 100 according to embodiments will be described with reference to FIGS. 1-7B.

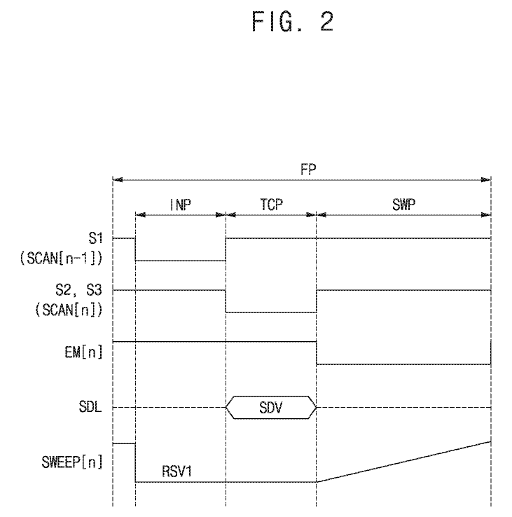

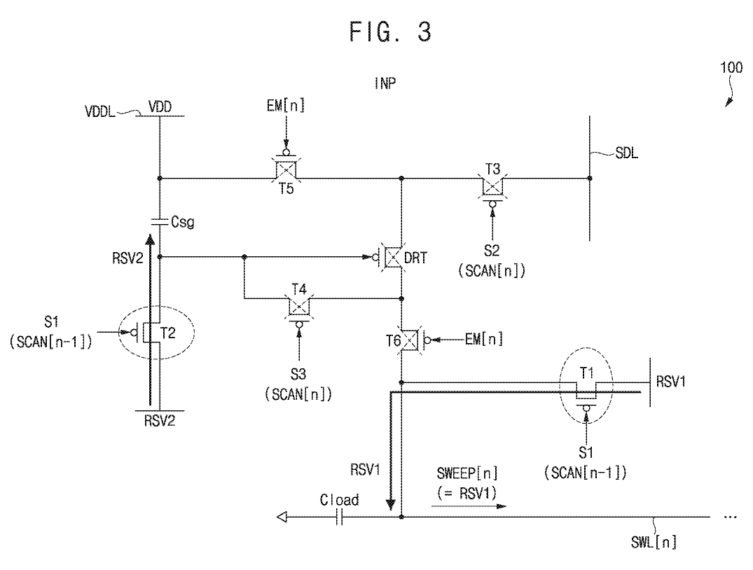

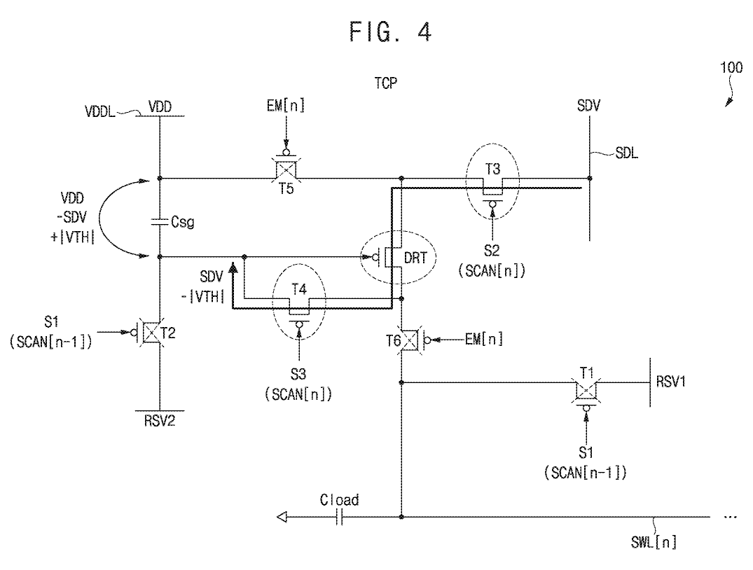

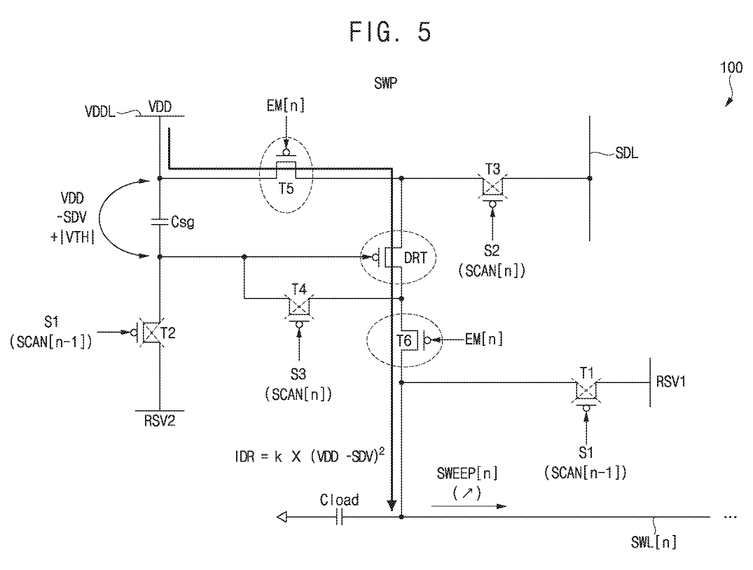

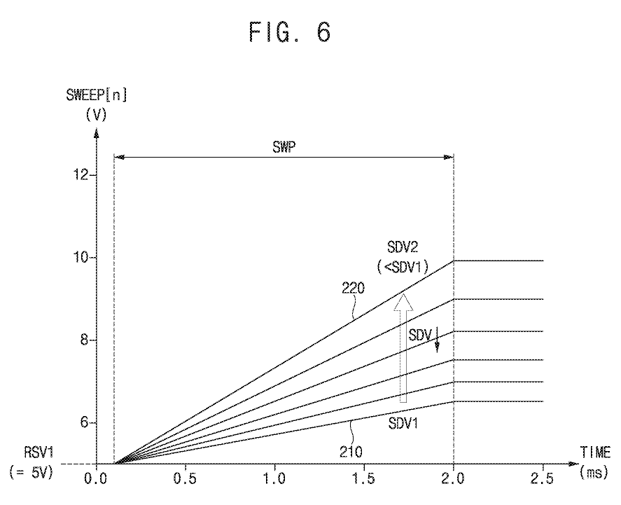

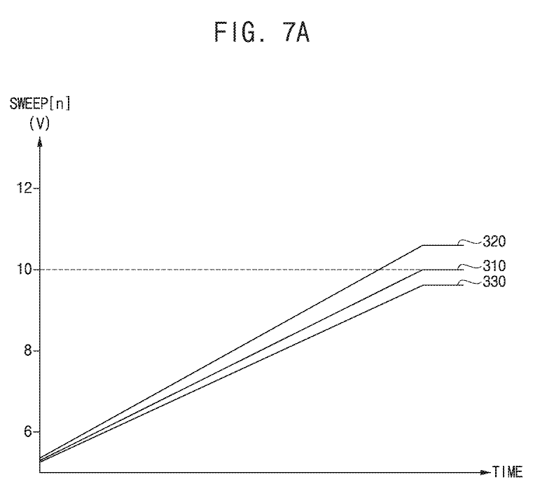

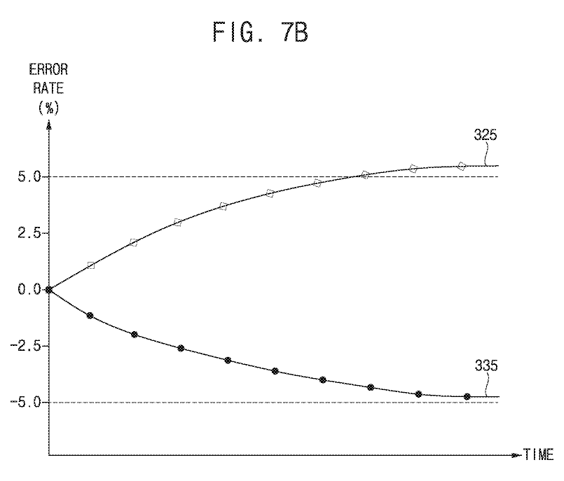

FIG. 2 is a signal timing diagram for describing an example of an operation of a sweep circuit according to embodiments, FIG. 3 is a circuit diagram for describing an example of an operation of a sweep circuit of FIG. 1 in an initialization period, FIG. 4 is a circuit diagram for describing an example of an operation of a sweep circuit of FIG. 1 in a threshold compensation period, FIG. 5 is a circuit diagram for describing an example of an operation of a sweep circuit of FIG. 1 in a sweep period, FIG. 6 is a diagram illustrating an example of sweep signals according to sweep data voltages, FIG. 7A is a diagram illustrating an example of sweep signals in a sweep period, and FIG. 7B is a diagram illustrating an example of error rates of the sweep signals of FIG. 7A.

Referring to FIGS. 1 and 2, a frame period FP of the display device including the sweep circuit 100 may include an initialization period INP in which the capacitor Csg and the load capacitor Cload are initialized, a threshold compensation period TCP in which the capacitor Csg stores the voltage in which the threshold voltage of the driving transistor DRT is compensated, and a sweep period SWP in which the sweep signal SWEEP[n] applied to the sweep line SWL[n] gradually changes (e.g., increases).

As illustrated in FIGS. 1 and 2, in the case where the sweep line SWL[n] is connected to the N-th pixel row among the plurality of pixel rows of the display panel, and the sweep circuit 100 provides the sweep signal SWEEP[n] to the N-th pixel row through the sweep line SWL[n], the first signal S1 may be the scan signal SCAN[n-1] for the (N-1)-th pixel row immediately preceding the N-th pixel row, and the second and third signals S2 and S3 may be a same scan signal as the scan signal SCAN[n] for the N-th pixel row. Further, each scan signal SCAN[n-1] and SCAN[n] may have an on-level (e.g., a low level) during one horizontal time. Here, one horizontal time may correspond to a time allocated for each pixel row, and may be calculated by dividing the frame period FP by the number of pixel rows in the display panel.

In the initialization period INP, the first signal S1 that is the scan signal SCAN[n-1] for the (N-1)-th pixel row may have the on-level (e.g., the low level), the second and third signals S2 and S3 that are the scan signal SCAN[n] for the N-th pixel row may have an off-level (e.g., a high level), and the emission signal EM[n] may have the off-level (e.g., the high level). As illustrated in FIG. 3, in the initialization period INP, the first transistor T1 may be turned on in response to the first signal S1 having the on-level, and may apply the first reset voltage RSV1 to the first electrode of the load capacitor Cload connected to the sweep line SWL[n]. Thus, the load capacitor Cload may be reset or initialized based on the first reset voltage RSV1 applied thereto through the first transistor T1, and the sweep signal SWEEP[n] applied to the sweep line SWL[n] connected to the load capacitor Cload may be initialized to the first reset voltage RSV1. Further, the second transistor T2 may be turned on in response to the first signal S1 having the on-level, and may apply the second reset voltage RSV2 to the second electrode of the capacitor Csg. Thus, the capacitor Csg may be reset or initialized based on the second reset voltage RSV2 applied thereto through the second transistor T2. In the initialization period INP, the driving transistor DRT, the third transistor T3, the fourth transistor T4, the fifth transistor T5 and the sixth transistor T6 may be turned off.

In the threshold compensation period TCP, the first signal S1 and the emission signal EM[n] may have the off-level, and the second and third signals S2 and S3 may have the on-level. As illustrated in FIG. 4, in the threshold compensation period TCP, the third transistor T3 may be turned on in response to the second signal S2 having the on-level, and may transfer the sweep data voltage SDV from the sweep data line SDL to the first terminal of the driving transistor DRT. That is, the third transistor T3 may apply the sweep data voltage SDV to the first terminal (e.g., the source) of the driving transistor DRT. The fourth transistor T4 may be turned on in response to the third signal S3 having the on-level, and may connect the gate and the second terminal (e.g., the drain) of the driving transistor DRT to each other, or may diode-connect the driving transistor DRT. Thus, a voltage SDV−|VTH| obtained by subtracting an absolute value of the threshold voltage |VTH| of the driving transistor DRT from the sweep data voltage SDV may be applied through the diode-connected driving transistor DRT to the gate of the driving transistor DRT, or the second electrode of the capacitor Csg. Further, the first electrode of the capacitor Csg may receive the power supply voltage VDD from the power supply voltage line VDDL. Accordingly, the capacitor Csg may store, between (or across) the first and second electrodes of the capacitor Csg, the voltage VDD−SDV+|VTH| in which the threshold voltage VTH of the driving transistor DRT is compensated, that is, a voltage VDD−SDV+|VTH| obtained by subtracting the sweep data voltage SDV from the power supply voltage VDD and adding the absolute value of the threshold voltage |VTH| of the driving transistor DRT. In the threshold compensation period TCP, the first transistor T1, the second transistor T2, the fifth transistor T5 and the sixth transistor T6 may be turned off.

In the sweep period SWP, the first, second and third signals S1, S2 and S3 may have the off-level, and the emission signal EM[n] may have the on-level. As illustrated in FIG. 5, in the sweep period SWP, the fifth and sixth transistors T5 and T6 may be turned on in response to the emission signal EM[n], and may form the path for the current IDR generated by the driving transistor DRT from the power supply voltage line VDDL to the load capacitor Cload. Further, the driving transistor DRT may generate the current IDR based on the voltage VDD−SDV+|VTH| stored in the capacitor Csg. Since the first electrode of the capacitor Csg is connected to the source of the driving transistor DRT through the fifth transistor T5 and the second electrode of the capacitor Csg is connected to the gate of the driving transistor DRT, a source-gate voltage of the driving transistor DRT may be the voltage VDD−SDV+|VTH| stored in the capacitor Csg. Thus, the current IDR generated by the driving transistor DRT may be determined by the equation “IDR = k × (VDD − SDV + |VTH| − |VTH|)² = k × (VDD − SDV)²”, where k is a coefficient determined by a mobility, an oxide capacitance, a channel width, a channel length, etc. of the driving transistor DRT. Accordingly, during the sweep period SWP, the driving transistor DRT may continuously provide the current IDR corresponding to a voltage difference VDD−SDV between the power supply voltage VDD and the sweep data voltage SDV to the load capacitor Cload independently of the threshold voltage VTH of the driving transistor DRT. As the current IDR generated by the driving transistor DRT is continuously provided to the load capacitor Cload, a voltage of the first electrode of the load capacitor Cload connected to the sweep line SWL[n] may gradually change (e.g., increase), and thus the sweep signal SWEEP[n] that gradually changes (e.g., increases) may be applied to the sweep line SWL[n].

In some embodiments, a slope of the sweep signal SWEEP[n] during the sweep period SWP may vary depending on the sweep data voltage SDV. In an embodiment, for example, as illustrated in FIG. 6, when a first sweep data voltage SDV1 having a relatively high voltage level close to the power supply voltage VDD is applied to the sweep circuit 100, a magnitude of the current IDR generated by the driving transistor DRT may be relatively small, and thus a sweep signal 210 having a relatively small slope may be applied to the sweep line SWL[n]. In another embodiment t, for example, when a second sweep data voltage SDV2 having a relatively low voltage level is applied to the sweep circuit 100, a magnitude of the current IDR generated by the driving transistor DRT may be relatively large, and thus a sweep signal 220 having a relatively large slope may be applied to the sweep line SWL[n]. Thus, the slope of the sweep signal SWEEP[n] may increase as the sweep data voltage SDV decreases, but is not limited thereto.

Further, in FIG. 7A, with respect to the sweep data voltage SDV that causes the sweep signal SWEEP[n] to increase to about 10 V at an end time point of the sweep period SWP, 310 indicates a first sweep signal during the sweep period SWP when only the threshold voltage VTH of the driving transistor DRT is changed, and 320 and 330 indicate second and third sweep signals during the sweep period SWP when not only the threshold voltage VTH but also other parameters (e.g., a subthreshold swing and/or a mobility) of the driving transistor DRT are changed. In FIG. 7A, 320 may indicate the second sweep signal when the subthreshold swing of the driving transistor DRT decreases or the mobility of the driving transistor DRT increases, and 330 may indicate the third sweep signal when the subthreshold swing of the driving transistor DRT increases or the mobility of the driving transistor DRT decreases. Since the sweep circuit 100 according to embodiments compensates for the threshold voltage VTH of the driving transistor DRT, as illustrated in FIG. 7A, when only the threshold voltage VTH of the driving transistor DRT is changed, the first sweep signal 310 may increase to a desired voltage level of about 10 V with a desired slope during the sweep period SWP. Further, in FIG. 7B, 325 indicates an error rate of the second sweep signal 320 with respect to the first sweep signal 310 of FIG. 7A, and 335 indicates an error rate of the third sweep signal 330 with respect to the first sweep signal 310 of FIG. 7A. As illustrated in FIGS. 7A and 7B, even if the other parameters (e.g., the subthreshold swing and/or the mobility) different from the threshold voltage VTH of the driving transistor DRT are changed, the error rates 325 and 335 of the second and third sweep signals 320 and 330 generated by the sweep circuit 100 according to embodiments may be within about 5.5%.

As described above, in the sweep circuit 100 according to embodiments, the capacitor Csg may store the voltage VDD−SDV+|VTH| in which the threshold voltage VTH of the driving transistor DRT is compensated in the threshold compensation period TCP, and the driving transistor DRT may provide the substantially constant current IDR corresponding to the voltage difference VDD−SDV between the power supply voltage VDD and the sweep data voltage SDV to the load capacitor Cload independently of the threshold voltage VTH of the driving transistor DRT during the sweep section SWP. Accordingly, the sweep circuit 100 according to embodiments may accurately generate the desired sweep signal SWEEP[n].

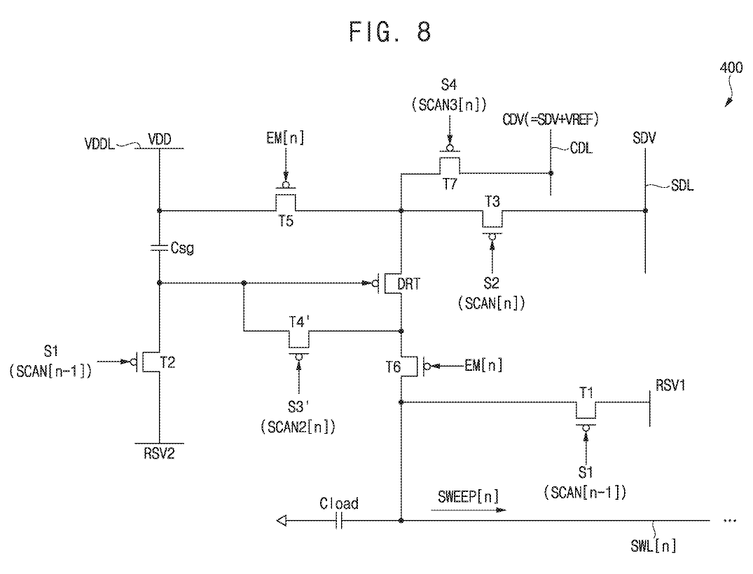

FIG. 8 is a circuit diagram illustrating a sweep circuit according to embodiments.

Referring to FIG. 8, a sweep circuit 400 according to embodiments may include a driving transistor DRT, a capacitor Csg, a first transistor T1, a second transistor T2, a third transistor T3, a fourth transistor T4’, a fifth transistor T5, a sixth transistor T6 and a seventh transistor T7. The sweep circuit 400 of FIG. 8 may have a same or like configuration and operation as those of the sweep circuit 100 of FIG. 1, except that a third signal S3’ applied to the fourth transistor T4’ is different from a second signal S2 applied to the third transistor T3, and that the sweep circuit 400 further includes the seventh transistor T7 that applies a compensation data voltage CDV to a first terminal of the driving transistor DRT in response to a fourth signal S4.

In some embodiments, where the sweep circuit 400 provides a sweep signal SWEEP[n] to an N-th pixel row among a plurality of pixel rows of a display panel, where N is an integer greater than or equal to 2, a first signal S1 applied to the first and second transistors T1 and T2 may be a first scan signal SCAN[n-1] for an (N-1)-th pixel row immediately preceding the N-th pixel row, the second signal S2 applied to the third transistor T3 may be a first scan signal SCAN[n] for the N-th pixel row, the third signal S3’ applied to the fourth transistor T4’ may be a second scan signal SCAN2[n] different from the first scan signal SCAN[n] for the N-th pixel row, and the fourth signal S4 applied to the seventh transistor T7 may be a third scan signal SCAN3[n] different from both the first and second scan signals SCAN[n] and SCAN2[n] for the N-th pixel row.

The seventh transistor T7 may apply the compensation data voltage CDV higher than a sweep data voltage SDV to the first terminal (e.g., a source) of the driving transistor DRT in response to the fourth signal S4. In some embodiments, the compensation data voltage CDV may be generated by adding a reference voltage VREF to the sweep data voltage SDV. Further, in some embodiments, the seventh transistor T7 may include a gate which receives the fourth signal S4, a first terminal connected to a compensation data line CDL, and a second terminal connected to the first terminal of the driving transistor DRT.

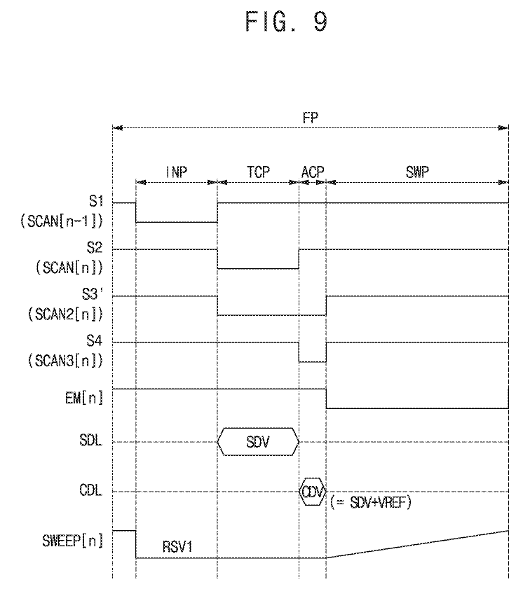

In some embodiments, in an additional compensation period (ACP in FIG. 9) following a threshold compensation period (TCP in FIG. 9), the third and fourth signals S3’ and S4 may have an on-level (e.g., a low level), the fourth transistor T4’ may diode-connect the driving transistor DRT in response to the third signal S3’, and the seventh transistor T7 may apply the compensation data voltage CDV corresponding to a sum of the sweep data voltage SDV and the reference voltage VREF to the source of the driving transistor DRT in response to the fourth signal S4. In this case, since the sweep data voltage SDV is applied to the source of the driving transistor DRT in the threshold compensation period, and the compensation data voltage CDV corresponding to the sum of the sweep data voltage SDV and the reference voltage VREF is applied to the source of the driving transistor DRT in the additional compensation period following the threshold compensation period, a voltage of a gate of the driving transistor DRT in the additional compensation period may be increased by a product of the reference voltage VREF and a compensation coefficient. In some embodiments, the compensation coefficient may be determined based on at least one selected from a subthreshold swing and a mobility of the driving transistor DRT. In an embodiment, for example, the compensation coefficient may increase as the mobility of the driving transistor DRT increases, and may decrease as the mobility decreases. Further, the compensation coefficient may increase as the subthreshold swing decreases, and may decrease as the subthreshold swing increases.

Even if the threshold voltage of the driving transistor DRT is compensated in the threshold compensation period, when the mobility of the driving transistor DRT increases, a current generated by the driving transistor DRT in the sweep period may increase, which causes a slope of the sweep signal SWEEP[n] during the sweep period to exceed a desired slope. However, in the sweep circuit 400 according to embodiments, when the mobility of the driving transistor DRT increases, the compensation coefficient may increase, the voltage of the gate of the driving transistor DRT in the additional compensation period following the threshold compensation period may be increased by the product of the reference voltage VREF and the increased compensation coefficient, and the voltage stored between (or across) the first and second electrodes of the capacitor Csg may be decreased. Thus, even if the mobility of the driving transistor DRT increases, the voltage stored in the capacitor Csg may decrease, the driving transistor DRT may generate the current having a desired current level in the sweep period, and the sweep signal SWEEP[n] may have the desired slope during the sweep period. In other words, in the sweep circuit 400 according to embodiments, parameters (e.g., the subthreshold swing and/or the mobility) other than the threshold voltage of the driving transistor DRT may be compensated in the additional compensation period.

Hereinafter, an operation of the sweep circuit 400 according to embodiments is described with reference to FIGS. 8-15B.

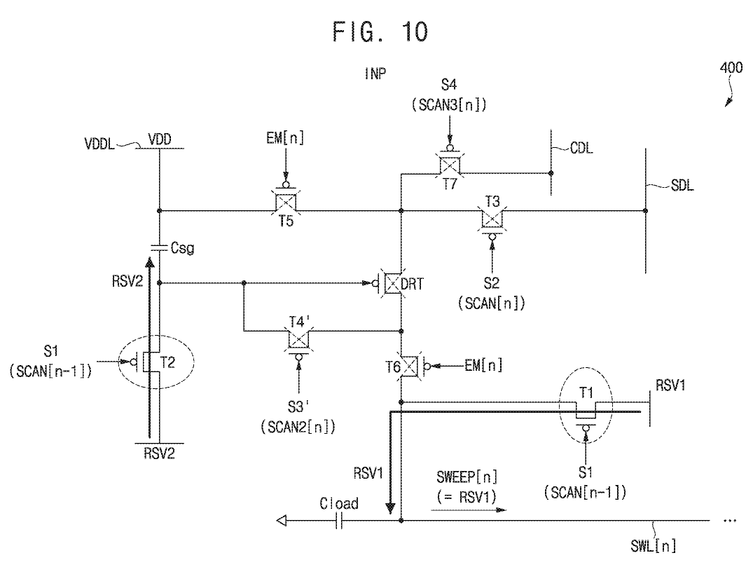

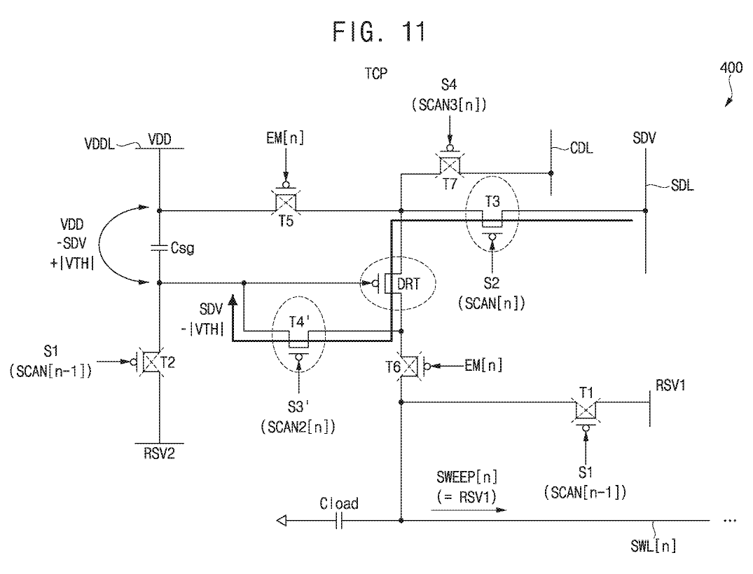

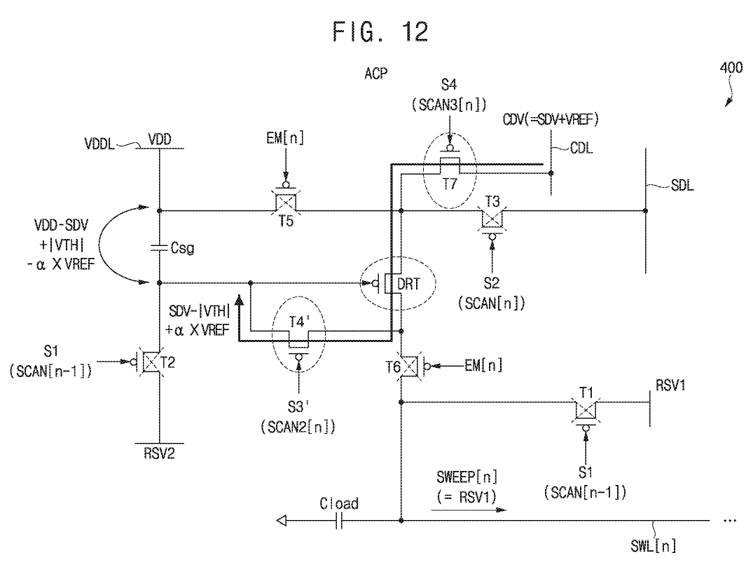

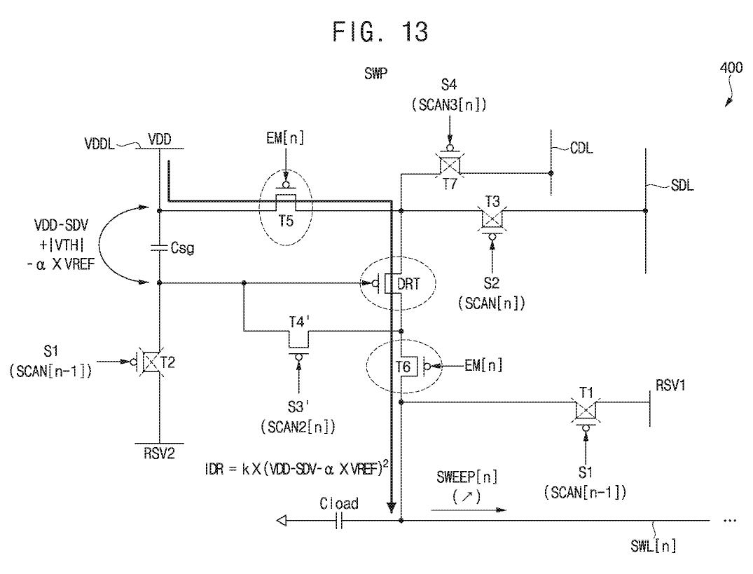

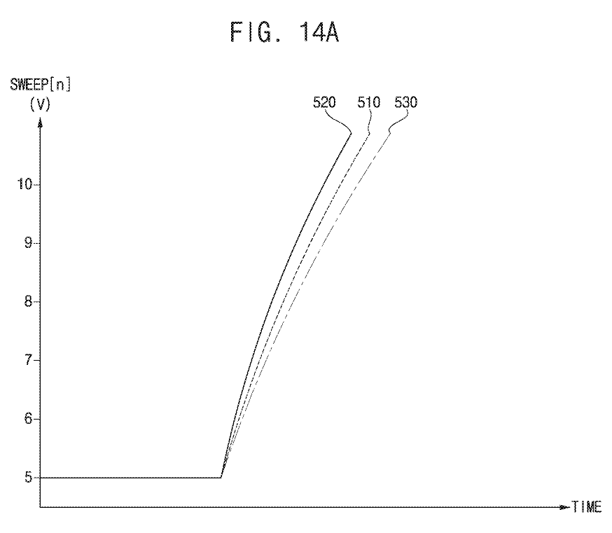

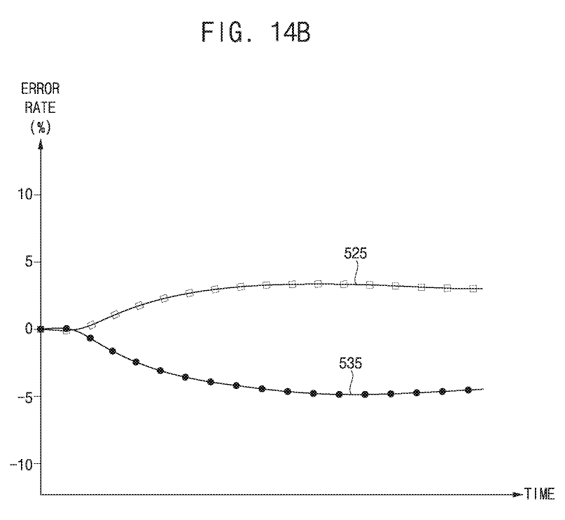

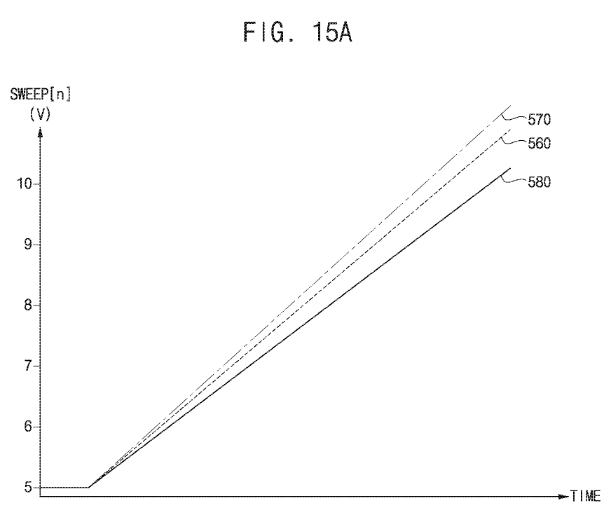

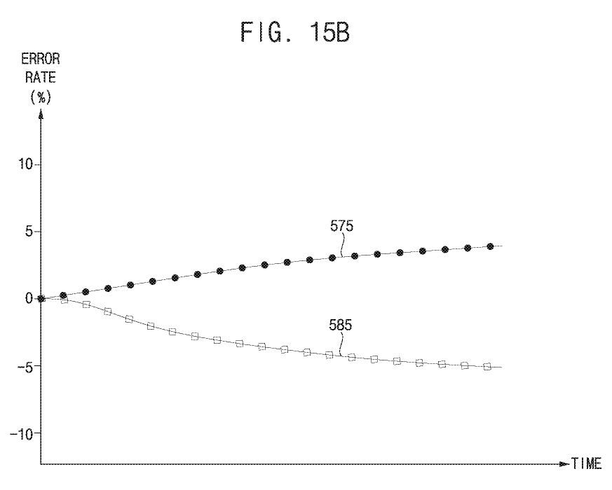

FIG. 9 is a signal timing diagram for describing an example of an operation of a sweep circuit according to embodiments, FIG. 10 is a circuit diagram for describing an example of an operation of a sweep circuit of FIG. 8 in an initialization period, FIG. 11 is a circuit diagram for describing an example of an operation of a sweep circuit of FIG. 8 in a threshold compensation period, FIG. 12 is a circuit diagram for describing an example of an operation of a sweep circuit of FIG. 8 in an additional compensation period, FIG. 13 is a circuit diagram for describing an example of an operation of a sweep circuit of FIG. 8 in a sweep period, FIG. 14A is a diagram illustrating an example of sweep signals in a sweep period, FIG. 14B is a diagram illustrating an example of error rates of the sweep signals of FIG. 14A, FIG. 15A is a diagram illustrating another example of sweep signals in a sweep period, and FIG. 15B is a diagram illustrating an example of error rates of the sweep signals of FIG. 15A.

Referring to FIGS. 8 and 9, a frame period FP of a display device including the sweep circuit 400 may include an initialization period INP in which the capacitor Csg and the load capacitor Cload are initialized, a threshold compensation period TCP in which the capacitor Csg stores a voltage in which the threshold voltage of the driving transistor DRT is compensated, an additional compensation period ACP in which the voltage of the gate of the driving transistor DRT is increased, and a sweep period SWP in which the sweep signal SWEEP[n] applied to a sweep line SWL[n] gradually changes.

As illustrated in FIGS. 8 and 9, in an embodiment where the sweep line SWL[n] is connected to the N-th pixel row among the plurality of pixel rows of the display panel, and the sweep circuit 400 provides the sweep signal SWEEP[n] to the N-th pixel row through the sweep line SWL[n], the first signal S1 may be the first scan signal SCAN[n-1] for the (N-1)-th pixel row immediately preceding the N-th pixel row, the second signal S2 may be the first scan signal SCAN[n] for the N-th pixel row, the third signal S3’ may be the second scan signal SCAN2[n] different from the first scan signal SCAN[n] for the N-th pixel row, and the fourth signal S4 may be the third scan signal SCAN3[n] different from the first and second scan signals SCAN[n] and SCAN2[n] for the N-th pixel row. Further, the first signal S1, or the first scan signal SCAN[n-1] for the (N-1)-th pixel row may have an on-level (e.g., a low level) during the initialization period INP; the second signal S2, or the first scan signal SCAN[n] for the N-th pixel row may have the on-level during the threshold compensation period TCP; the third signal S3’, or the second scan signal SCAN2[n] for the N-th pixel row may have the on-level during the threshold compensation period TCP and the additional compensation period ACP; and the fourth signal S4, or the third scan signal SCAN3[n] for the N-th pixel row may have the on-level during the additional compensation period ACP. Furthermore, the additional compensation period ACP may have a time length shorter than a time length of the threshold compensation period TCP. In an embodiment, for example, each of the initialization period INP and the threshold compensation period TCP may have a time length corresponding to one horizontal time, and the additional compensation period ACP may have a time length shorter than one horizontal time. In some embodiments, the time length of the sweep period SWP may be changed depending on a mode (e.g., a luminance mode) of the display device including the sweep circuit 400. In an embodiment, for example, the sweep period SWP may have a relatively long time length in a high luminance mode of the display device, and a relatively short time length in a low luminance mode of the display device, but is not limited thereto.

In the initialization period INP, as illustrated in FIG. 10, the first and second transistors T1 and T2 may be turned on in response to the first signal S1 having the on-level, the load capacitor Cload may be initialized based on the first reset voltage RSV1 applied thereto through the first transistor T1, and the capacitor Csg may be initialized based on the second reset voltage RSV2 applied thereto through the second transistor T2. Further, the sweep signal SWEEP[n] applied to the sweep line SWL[n] may be initialized to the first reset voltage RSV1.

In the threshold compensation period TCP, as illustrated in FIG. 11, the third transistor T3 may be turned on in response to the second signal S2 having the on-level, the fourth transistor T4 may be turned on in response to the third signal S3’ having the on-level, and a voltage SDV−|VTH| obtained by subtracting an absolute value of the threshold voltage |VTH| of the driving transistor DRT from the sweep data voltage SDV may be applied to the gate of the driving transistor DRT, or a second electrode of the capacitor Csg. Thus, the capacitor Csg may store, between (or across) the first and second electrodes of the capacitor Csg, a voltage VDD−SDV+|VTH| in which the threshold voltage VTH of the driving transistor DRT is compensated, or a voltage VDD−SDV+|VTH| obtained by subtracting the sweep data voltage SDV from the power supply voltage VDD and adding the absolute value of the threshold voltage |VTH| of the driving transistor DRT.

In the additional compensation period ACP following the threshold compensation period TCP, the first signal S1, the second signal S2 and the emission signal EM[n] have an off-level (e.g., a high level), and the third signal S3’ and the fourth signal S4 may have the on-level (e.g., the low level). In the additional compensation period ACP, as illustrated in FIG. 12, the seventh transistor T7 may be turned on in response to the fourth signal S4 having the on-level, and may apply the compensation data voltage CDV corresponding to the sum of the sweep data voltage SDV and the reference voltage VREF to a first terminal (e.g., a source) of the driving transistor DRT. Further, the fourth transistor T4’ may be turned on in response to the third signal S3’ having the on-level, and may diode-connect the driving transistor DRT. Thus, the voltage of the gate of the driving transistor DRT may increase from “SDV−|VTH|” toward “CDV−|VTH| = SDV−|VTH|+VREF”. However, the additional compensation period ACP may have a time length shorter than a time length (i.e., one horizontal time) of the threshold compensation period TCP. Thus, in the additional compensation period ACP, the voltage of the gate of the driving transistor DRT may not be increased up to “SDV−|VTH|+VREF”, but may be increased by the product of the reference voltage VREF and a compensation coefficient α to “SDV−|VTH|+α×VREF”. In some embodiments, the compensation coefficient α may be less than or equal to 1, and may be determined based on at least one selected from the subthreshold swing and the mobility of the driving transistor DRT. Accordingly, the voltage stored in the capacitor Csg may be changed (e.g., decreased) from “VDD−SDV+|VTH|” to “VDD−SDV+|VTH|−α×VREF”. In an embodiment, for example, as the mobility of the driving transistor DRT increases or the subthreshold swing of the driving transistor DRT decreases, the compensation coefficient α may increase, and the voltage stored in the capacitor Csg may be decreased by a relatively large amount. Alternatively, as the mobility of the driving transistor DRT decreases or the subthreshold swing of the driving transistor DRT increases, the compensation coefficient α may decrease, and the voltage stored in the capacitor Csg may be decreased by a relatively small amount. Accordingly, in the additional compensation period ACP, the parameters (e.g., the subthreshold swing and/or the mobility) other than the threshold voltage of the driving transistor DRT may be compensated.

In the sweep period SWP, as illustrated in FIG. 13, the fifth and sixth transistors T5 and T6 may be turned on in response to the emission signal EM[n], and the driving transistor DRT may generate the current IDR based on the voltage VDD−SDV+|VTH|−α×VREF stored in the capacitor Csg. The current IDR generated by the driving transistor DRT may be determined by an equation “IDR = k×(VDD−SDV+|VTH|−α×VREF−|VTH|)² = k×(VDD−SDV−α×VREF)², where k is a coefficient determined by a mobility, an oxide capacitance, a channel width, a channel length, etc. of the driving transistor DRT. Accordingly, during the sweep period SWP, the driving transistor DRT may continuously provide the current IDR corresponding to the voltage VDD−SDV−α×VREF obtained by subtracting the sweep data voltage SDV from the power supply voltage VDD and further subtracting the product of the reference voltage VREF and the compensation coefficient α, to the load capacitor Cload independently of the threshold voltage VTH of the driving transistor DRT. Even if the subthreshold swing and/or the mobility of the driving transistor DRT is changed, since the compensation coefficient α is adjusted according to the subthreshold swing and/or the mobility, the driving transistor DRT may generate the current IDR having a desired current level. Further, even if the current IDR generated by the driving transistor DRT is continuously provided to the load capacitor Cload, a voltage of the first electrode of the load capacitor Cload connected to the sweep line SWL[n] may be gradually changed (e.g., increased), and thus the sweep signal SWEEP[n] applied to the sweep line SWL[n] may gradually change (e.g., increases).

In FIG. 14A, with respect to the sweep period SWP having a relatively short time length (e.g., about 3.8 microseconds) and the same sweep data voltage SDV, 510 indicates the sweep signal SWEEP[n] when only the threshold voltage VTH of the driving transistor DRT changes or a target sweep signal SWEEP[n], 520 indicates a first sweep signal when the subthreshold swing decreases or the mobility increases, and 530 indicates a second sweep signal when the subthreshold swing increases or the mobility decreases. Further, in FIG. 14B, 525 indicates an error rate of the first sweep signal 520 with respect to the target sweep signal 510 of FIG. 14A, and 535 indicates an error rate of the second sweep signal 530 with respect to the target sweep signal 510 of FIG. 14A. As illustrated in FIGS. 14A and 14B, even if the parameters (e.g., the subthreshold swing and/or the mobility) other than the threshold voltage VTH of the driving transistor DRT change, the error rates 525 and 535 of the first and second sweep signals 520 and 530 generated by the sweep circuit 400 according to embodiments may be within about 4.63%.

Further, in FIG. 15A, with respect to the sweep period SWP having a relatively long time length (e.g., about 500 microseconds) and the same sweep data voltage SDV, 560 indicates the sweep signal SWEEP[n] when only the threshold voltage VTH of the driving transistor DRT changes or the target sweep signal SWEEP[n], 570 indicates a first sweep signal when the subthreshold swing decreases or the mobility increases, and 580 indicates a second sweep signal when the subthreshold swing increases or the mobility decreases. Further, in FIG. 15B, 575 indicates an error rate of the first sweep signal 570 with respect to the target sweep signal 560 of FIG. 15A, and 585 indicates an error rate of the second sweep signal 580 with respect to the target sweep signal 560 of FIG. 15A. As illustrated in FIGS. 15A and 15B, even if the parameters (e.g., the subthreshold swing and/or the mobility) other than the threshold voltage VTH of the driving transistor DRT change, the error rates 575 and 585 of the first and second sweep signals 570 and 580 generated by the sweep circuit 400 according to embodiments may be within about 4.79%.

As described above, the sweep circuit 400 according to embodiments may perform a threshold voltage compensation operation that compensates the threshold voltage VTH of the driving transistor DRT in the threshold compensation period TCP, and may perform an additional compensation operation that compensates not only the threshold voltage VTH but also the other parameters (e.g., the subthreshold swing and/or the mobility) of the driving transistor DRT in the additional compensation period ACP following the threshold compensation period TCP. Accordingly, the sweep circuit 400 according to embodiments may more accurately generate the desired sweep signal SWEEP[n].

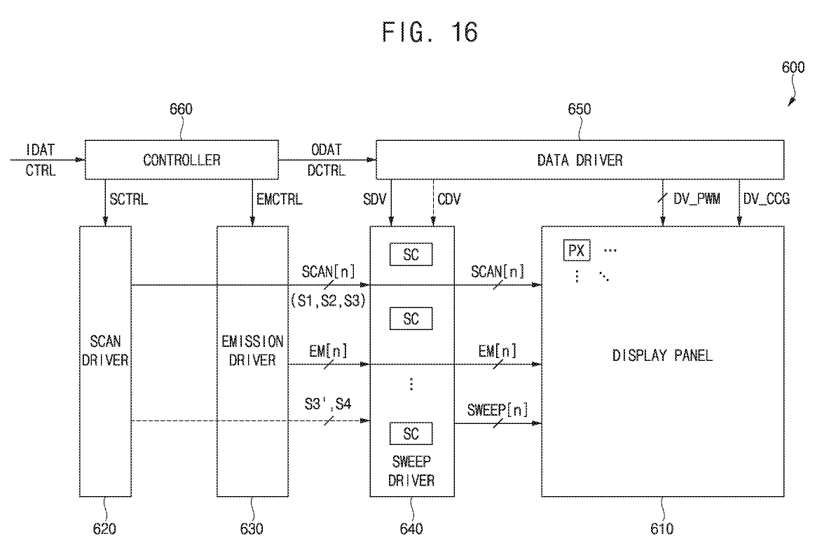

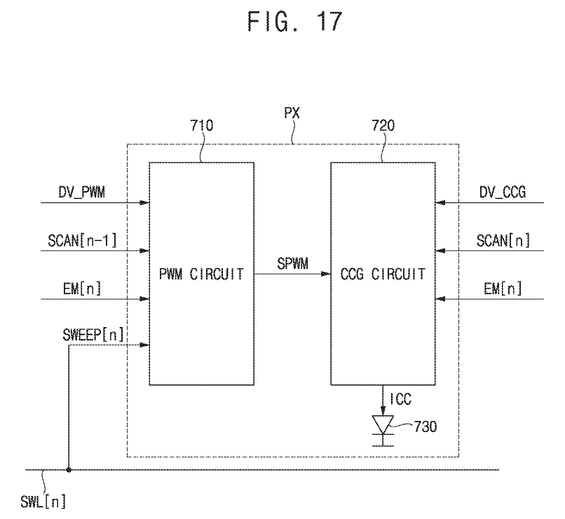

FIG. 16 is a block diagram illustrating a display device according to embodiments, and FIG. 17 is a diagram illustrating an example of a pixel included in a display device according to embodiments.

Referring to FIG. 16, a display device 600 according to embodiments may include a display panel 610 that includes a plurality of pixels PX, a scan driver 620 that provides a scan signal SCAN[n] to each of the plurality of pixels PX, an emission driver 630 that provides an emission signal EM[n] to each of the plurality of pixels PX, a sweep driver 640 that provides a sweep signal SWEEP[n] to each of the plurality of pixels PX, a data driver 650 that provides pulse width modulation (“PWM”) data voltage DV_PWM and a constant current generation (“CCG”) data voltage DV_CCG to each of the plurality of pixels PX, and a controller 660 that controls the scan driver 620, the emission driver 630 and the data driver 650.

The display panel 610 may include a plurality of data lines, a plurality of scan lines, a plurality of emission lines, a plurality of sweep lines, and the plurality of pixels PX connected thereto. In some embodiments, the plurality of data lines may extend in a first direction, and the plurality of scan lines, the plurality of emission lines and the plurality of sweep lines may extend in a second direction substantially perpendicular to the first direction. Further, in some embodiments, the plurality of data lines may include PWM data lines for providing the PWM data voltages DV_PWM to the plurality of pixels PX, CCG data lines for providing the CCG data voltage DV_CCG to the plurality of pixels PX, sweep data lines for providing a sweep data voltage SDV to a plurality of sweep circuits SC of the sweep driver 640, and/or compensation data lines for transferring a compensation data voltages CDV to the plurality of sweep circuits SC of the sweep driver 640.

In some embodiments, as illustrated in FIG. 17, each pixel PX of the display panel 610 may include a PWM circuit 710 that generates a PWM signal SPWM based on the PWM data voltage DV_PWM and the sweep signal SWEEP[n] applied thereto through the sweep line SWL[n], a CCG circuit 720 that generates an emission current ICC based on the CCG data voltage DV_CCG and the PWM signal SPWM, and a light-emitting element 730 that emits light based on the emission current ICC.

For example, the pixel PX of FIG. 17 may be located in an N-th pixel row among a plurality of pixel rows of the display panel 610, where N is an integer greater than or equal to 2, and the PWM circuit 710 of the pixel PX may store the PWM data voltage DV_PWM in response to a scan signal SCAN[n-1] for an (N-1)-th pixel row. Although FIG. 17 illustrates an embodiment where the PWM circuit 710 receives the scan signal SCAN[n-1] for the (N-1)-th pixel row, in other embodiments, the PWM circuit 710 may receive the scan signal SCAN[n] for the N-th pixel row together with or instead of the scan signal SCAN[n-1] for the (N-1)-th pixel row. In such an embodiment, the PWM circuit 710 may store the PWM data voltage DV_PWM in response to the scan signal SCAN[n] for the N-th pixel row. During a sweep period in which the emission signal EM[n] has an on-level (e.g., a low level), the PWM circuit 710 may receive the sweep signal SWEEP[n] that gradually increases through the sweep line SWL[n]. Further, the PWM circuit 710 may generate the PWM signal SPWM having the on-level during a period (e.g., an emission period), which starts at the beginning of the sweep period and ends when the sweep signal SWEEP[n] reaches the PWM data voltage DV_PWM. Thus, the PWM data voltage DV_PWM may be determined based on output image data ODAT for the pixel PX, and a time length of the period (e.g., the emission period) in which the PWM signal SPWM has the on-level may be adjusted based on the PWM data voltage DV_PWM. In an embodiment, for example, as the voltage level of the PWM data voltage DV_PWM increases, the time length of the period (e.g., the emission period) in which the PWM signal SPWM has the on-level may increase.

The CCG circuit 720 may store the CCG data voltage DV_CCG in response to the scan signal SCAN[n] for the N-th pixel row. In some embodiments, the CCG data voltages DV_CCG provided to the plurality of pixels PX of the display panel 610 may be substantially the same voltage independently of the output image data ODAT for the plurality of pixels PX. Further, a voltage level of the CCG data voltage DV_CCG may be determined such that the CCG circuit 720 provides the emission current ICC having a desired target current level to the light-emitting element 730. During the sweep period in which the emission signal EM[n] has the on-level, the CCG circuit 720 may receive the PWM signal SPWM from the PWM circuit 710, and may generate the emission current ICC in response to the PWM signal SPWM having the on-level. In other words, the CCG circuit 720 may provide the emission current ICC to the light-emitting element 730 during the period (e.g., the emission period) in which the PWM signal SPWM has the on-level.

The light-emitting element 730 may emit light based on the emission current ICC having the target current level provided from the CCG circuit 720. Further, since the time length of the period in which the PWM signal SPWM has the on-level is adjusted according to the PWM data voltage DV_PWM, the CCG circuit 720 provides the emission current ICC to the light-emitting element 730 during the period in which the PWM signal SPWM has the on-level, and the light-emitting element 730 emits light during the period in which the CCG circuit 720 provides the emission current ICC, a time length of the period (e.g., the emission period) in which the light-emitting element 730 emits light may be determined based on the voltage level of the PWM data voltage DV_PWM. Thus, the pixel PX may drive the light-emitting element 730 in a PWM method that adjusts the time length of the emission period according to the PWM data voltage DV_PWM. In some embodiments, the light-emitting element 730 may be, but is not limited to, a micro-light-emitting diode (“micro-LED”). In other embodiments, the light-emitting element 730 may be an organic light-emitting diode (“OLED”), a nano light-emitting diode (“nano-LED”), a quantum dot (“QD”) light-emitting diode, an inorganic light-emitting diode, or any other suitable light-emitting element.

Although FIG. 17 illustrates an example of each pixel PX of the display device 600 according to embodiments, the pixel PX of the display device 600 according to embodiments is not limited to the example of FIG. 17.

Referring again to FIG. 16, the scan driver 620 may generate the scan signals SCAN[n] based on a scan control signal SCTRL received from the controller 660, and may sequentially provide the scan signals SCAN[n] to the plurality of pixels PX on a pixel row basis. In some embodiments, the scan control signals SCTRL may include, but is not limited to, a scan start signal and a scan clock signal. Further, the scan driver 620 may provide a first signal S1, a second signal S2, a third signal S3 and S3’ and/or a fourth signal S4 to each sweep circuit SC of the sweep driver 640. In some embodiments, in a case where the sweep driver 640 includes a sweep circuit 100 of FIG. 1 as the sweep circuit SC, the scan driver 620 may provide the sweep circuit SC connected to the sweep line SWL[n] for the N-th pixel row with the scan signal SCAN[n-1] for the (N-1)-th pixel row as the first signal S1 and the scan signal SCAN[n] for the N-th pixel row as the second and third signals S2 and S3. In other embodiments, in a case where the sweep driver 640 includes a sweep circuit 400 of FIG. 8 as the sweep circuit SC, the scan driver 620 may provide the sweep circuit SC connected to the sweep line SWL[n] for the N-th pixel row with the scan signal SCAN[n-1] for the (N-1)-th pixel row as the first signal S1, the scan signal SCAN[n] for the N-th pixel row as the second signal S2, and third and fourth signals S3’ and S4 different from the scan signals SCAN[n] provided to the plurality of pixels PX. In some embodiments, the scan driver 620 may be integrated or formed in the display panel 610. In other embodiments, the scan driver 620 may be implemented as one or more integrated circuits.

The emission driver 630 may generate the emission signals EM[n] based on an emission control signal EMCTRL received from the controller 660, and sequentially provide the emission signals EM[n] to the plurality of pixels PX on a pixel row basis. In some embodiments, the emission control signals EMCTRL may include, but is not limited to, an emission start signal and an emission clock signal. In some embodiments, the emission driver 630 may be integrated or formed in the display panel 610. In other embodiments, the emission driver 630 may be implemented as one or more integrated circuits.

The sweep driver 640 may include a plurality of sweep circuits SC respectively connected to the plurality of sweep lines of the display panel 610. In some embodiments, the number of the plurality of sweep circuits SC may correspond to, but is not limited to, the number of pixel rows of the display panel 610. The plurality of sweep circuits SC of the sweep driver 640 may sequentially provide the sweep signals SWEEP[n] to the plurality of pixels PX on a pixel row-by-pixel row basis through the plurality of sweep lines. According to embodiments, each sweep circuit SC of the sweep driver 640 may be the sweep circuit 100 of FIG. 1, the sweep circuit 400 of FIG. 8, or a similar sweep circuit. Each sweep circuit SC may provide the sweep signal SWEEP[n] that gradually changes (e.g., increases) to the sweep line SWL[n] by supplying a current to a load capacitor connected to the sweep line SWL[n] using P-type transistors (e.g., PMOS LTPS TFTs). Further, each sweep circuit SC may accurately generate a desired sweep signal SWEEP[n] by compensating for a threshold voltage, a subthreshold swing and/or a mobility of a driving transistor of the sweep circuit SC. In some embodiments, the sweep driver 640 may be integrated or formed in the display panel 610. In other embodiments, the sweep driver 640 may be implemented as one or more integrated circuits.

The data driver 650 may receive a data control signal DCTRL and the output image data ODAT from the controller 660, may provide the PWM data voltages DV_PWM to the plurality of pixels PX based on the output image data ODAT, and may provide substantially the same CCG data voltage DV_CCG to the plurality of pixels PX. In some embodiments, the voltage level of each PWM data voltage DV_PWM for each pixel PX may be determined based on a gray level indicated by the output image data ODAT for the pixel PX. Further, in some embodiments, the data driver 650 may provide substantially the same CCG data voltage DV_CCG to the plurality of pixels PX. In some embodiments, the data control signals DCTRL may include, but is not limited to, an output data enable signal, a horizontal start signal and a load signal. Further, the data driver 650 may provide the sweep data voltage SDV and/or the compensation data voltages CDV to the plurality of sweep circuits SC of the sweep driver 640. In some embodiments, the data driver 650 and the controller 660 may be implemented as a single integrated circuit, and the single integrated circuit may be referred to as a timing controller embedded data driver (“TED”) integrated circuit. In other embodiments, the data driver 650 and the controller 660 may be implemented as separate integrated circuits.

The controller 660 (e.g., a timing controller) may receive input image data IDAT and a control signal CTRL from an external processor (e.g., a graphics processing unit (“GPU”), an application processor (“AP”) or a graphics card). In some embodiments, the control signals CTRL may include, but is not limited to, a vertical synchronization signal, a horizontal synchronization signal, an input data enable signal, a master clock signal, or the like. The controller 660 may generate the output image data ODAT, the data control signal DCTRL, the scan control signal SCTRL and the emission control signal EMCTRL based on the input image data IDAT and the control signals CTRL. The controller 660 may control the data driver 650 by providing the output image data ODAT and the data control signal DCTRL to the data driver 650, may control the scan driver 620 by providing the scan control signals SCTRL to the scan driver 620, and may control the emission driver 630 by providing the emission control signal EMCTRL to the emission driver 630.

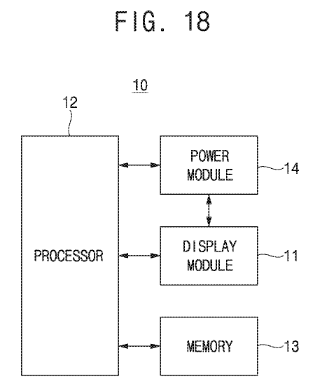

FIG. 18 is a block diagram illustrating an electronic device according to embodiments.

Referring to FIG. 18, an electronic device 10 according to embodiments may include a display module 11, a processor 12, a memory 13 and a power module 14.

The processor 12 may include at least one selected from a central processing unit (“CPU”), an application processor (“AP”), a graphics processing unit (“GPU”), a communication processor (“CP”), an image signal processor (“ISP”) and a controller.

The memory 13 may store data information for an operation of the processor 12 or the display module 11. When the processor 12 executes an application stored in the memory 13, an image data signal and/or an input control signal may be transferred to the display module 11, and the display module 11 may output image information through a display screen by processing the received signal.

The power module 14 may include a power supply module such as a power adapter or a battery device, and a power conversion module that converts power supplied by the power supply module to generate power for an operation of the electronic device 10.

At least one of components of the electronic device 10 described above may be included in the display device (e.g., a display device 600 of FIG. 16) described above according to embodiments. Further, some of individual modules functionally included in one module may be included in the display device, and other modules may be provided separately from the display device. In an embodiment, for example, the display device may include the display module 11, and the processor 12, the memory 13 and the power module 14 may be provided in the form of other devices within the electronic device 10 other than the display device.

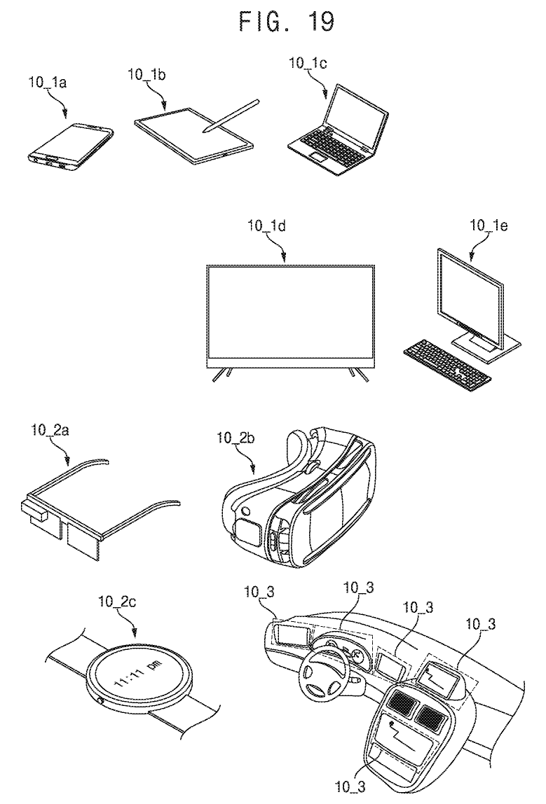

FIG. 19 is a schematic diagram illustrating electronic devices according to various embodiments.

Referring to FIG. 19, various electronic devices to which the display device according to embodiments is applied may include not only image display electronic devices such as a smart phone 10_1a, a tablet personal computer (“PC”) 10_1b, a laptop computer 10_1c, a television (“TV”) 10_1d and a desk monitor 10_1e, but also wearable electronic devices including display modules such as smart glasses 10_2a, a head mounted display 10_2b and a smart watch 10_2c, and vehicle electronic devices 10_3 including display modules such as a center information display (“CID”) arranged on an instrument panel, center fascia and dashboard of an automobile, and a room mirror display.

The invention should not be construed as being limited to the embodiments set forth herein. Rather, these embodiments are provided so that this disclosure will be thorough and complete and will fully convey the concept of the invention to those skilled in the art.

While the invention has been particularly shown and described with reference to embodiments thereof, it will be understood by those of ordinary skill in the art that various changes in form and details may be made therein without departing from the spirit or scope of the invention as defined by the following claims.

What is claimed is:

1. A sweep circuit comprising:
a driving transistor including a gate, a first terminal and a second terminal;
a capacitor including a first electrode connected to a power supply voltage line, and a second electrode connected to the gate of the driving transistor;
a first transistor which applies a first reset voltage to a load capacitor connected to a sweep line in response to a first signal;
a second transistor which applies a second reset voltage to the second electrode of the capacitor in response to the first signal;
a third transistor which transfers a sweep data voltage to the first terminal of the driving transistor in response to a second signal;
a fourth transistor which connects the gate and the second terminal of the driving transistor to each other in response to a third signal;
a fifth transistor which connects the first terminal of the driving transistor to the power supply voltage line in response to an emission signal; and
a sixth transistor which connects the second terminal of the driving transistor to the sweep line in response to the emission signal.

2. The sweep circuit of claim 1, wherein, in a threshold compensation period of a frame period, the fourth transistor diode-connects the driving transistor, and the capacitor stores a voltage in which a threshold voltage of the driving transistor is compensated through the diode-connected driving transistor.

3. The sweep circuit of claim 1, wherein, in a sweep period of a frame period, the driving transistor continuously supplies a current to the load capacitor to apply a sweep signal which gradually changes to the sweep line.

4. The sweep circuit of claim 1, wherein the driving transistor, the first transistor, the second transistor, the third transistor, the fourth transistor, the fifth transistor and the sixth transistor are P-type transistors.

5. The sweep circuit of claim 1, wherein the first transistor includes a gate which receives the first signal, a first terminal connected to the load capacitor, and a second terminal which receives the first reset voltage,
the second transistor includes a gate which receives the first signal, a first terminal connected to the second electrode of the capacitor, and a second terminal which receives the second reset voltage,
the third transistor includes a gate which receives the second signal, a first terminal connected to a sweep data line through which the sweep data voltage is transferred, and a second terminal connected to the first terminal of the driving transistor,
the fourth transistor includes a gate which receives the third signal, a first terminal connected to the second terminal of the driving transistor, and a second terminal connected to the gate of the driving transistor,
the fifth transistor includes a gate which receives the emission signal, a first terminal connected to the power supply voltage line, and a second terminal connected to the first terminal of the driving transistor, and
the sixth transistor includes a gate which receives the emission signal, a first terminal connected to the second terminal of the driving transistor, and a second terminal connected to the sweep line.

6. The sweep circuit of claim 1, wherein the sweep circuit provides a sweep signal to an N-th pixel row among a plurality of pixel rows of a display panel through the sweep line, wherein N is an integer greater than or equal to 2,
the first signal is a scan signal for an (N-1)-th pixel row, and
the second signal and the third signal are a same scan signal as a scan signal for the N-th pixel row.

7. The sweep circuit of claim 1, wherein a frame period of a display device including the sweep circuit comprises:
an initialization period in which the capacitor and the load capacitor are initialized;
a threshold compensation period in which the capacitor stores a voltage in which a threshold voltage of the driving transistor is compensated; and
a sweep period in which a sweep signal applied to the sweep line gradually changes.

8. The sweep circuit of claim 7, wherein, in the initialization period,
the first signal has an on-level,
the second signal, the third signal and the emission signal have an off-level,
the first and second transistors are turned on in response to the first signal having the on-level,
the load capacitor is initialized based on the first reset voltage applied thereto through the first transistor; and
the capacitor is initialized based on the second reset voltage applied thereto through the second transistor.

9. The sweep circuit of claim 7, wherein, in the threshold compensation period,
the first signal and the emission signal have an off-level,
the second signal and the third signal have an on-level,
the third transistor is turned on in response to the second signal having the on-level and applies the sweep data voltage to the first terminal of the driving transistor,
the fourth transistor is turned on in response to the third signal having the on-level and diode-connects the driving transistor, and
the capacitor stores, between the first and second electrodes of the capacitor, a voltage obtained by subtracting the sweep data voltage from a power supply voltage of the power supply voltage line and adding an absolute value of the threshold voltage of the driving transistor.

10. The sweep circuit of claim 7, wherein, in the sweep period,
the first signal, the second signal, and the third signal have an off-level,
the emission signal has an on-level,
the driving transistor continuously supplies a current corresponding to a voltage difference between a power supply voltage of the power supply voltage line and the sweep data voltage to the load capacitor, and
the sweep signal that gradually changes is applied to the sweep line.

11. The sweep circuit of claim 1, further comprising:
a seventh transistor which applies a compensation data voltage higher than the sweep data voltage to the first terminal of the driving transistor in response to a fourth signal.

12. The sweep circuit of claim 11, wherein the compensation data voltage is generated by adding a reference voltage to the sweep data voltage.

13. The sweep circuit of claim 12, wherein, in an additional compensation period of a frame period, a voltage of the gate of the driving transistor is increased by a product of the reference voltage and a compensation coefficient, and
wherein the compensation coefficient is determined based on at least one selected from a subthreshold swing and a mobility of the driving transistor.

14. The sweep circuit of claim 11, wherein the seventh transistor includes a gate which receives the fourth signal, a first terminal connected to a compensation data line, and a second terminal connected to the first terminal of the driving transistor.

15. The sweep circuit of claim 11, wherein the sweep circuit provides a sweep signal to an N-th pixel row among a plurality of pixel rows of a display panel through the sweep line, wherein N is an integer greater than or equal to 2,
the first signal is a first scan signal for an (N-1)-th pixel row,
the second signal is a first scan signal for the N-th pixel row;
the third signal is a second scan signal different from the first scan signal for the N-th pixel row, and
the fourth signal is a third scan signal different from the first and second scan signals for the N-th pixel row.

16. The sweep circuit of claim 11, wherein a frame period of a display device including the sweep circuit comprises:
an initialization period in which the capacitor and the load capacitor are initialized;
a threshold compensation period in which the capacitor stores a voltage in which a threshold voltage of the driving transistor is compensated;
an additional compensation period in which a voltage of the gate of the driving transistor is increased; and
a sweep period in which a sweep signal applied to the sweep line gradually changes.

17. The sweep circuit of claim 16, wherein, in the additional compensation period,
the first signal, the second signal and the emission signal have an off-level,
the third signal and the fourth signal have an on-level,
the seventh transistor is turned on in response to the fourth signal having the on-level and applies the compensation data voltage corresponding to a sum of the sweep data voltage and a reference voltage to the first terminal of the driving transistor,
the fourth transistor is turned on in response to the third signal having the on-level and diode-connects the driving transistor, and
the voltage of the gate of the driving transistor is increased by a product of the reference voltage and a compensation coefficient.

18. A display device comprising:
a display panel including a plurality of sweep lines and a plurality of pixels connected to the plurality of sweep lines;
a sweep driver including a plurality of sweep circuits respectively connected to the plurality of sweep lines;
a scan driver which provides a scan signal to each of the pixels, and provides a first signal, a second signal and a third signal to each of the plurality of sweep circuits;
an emission driver which provides an emission signal to each of the plurality of pixels and each of the plurality of sweep circuits;
a data driver which provides a pulse width modulation data voltage and a constant current generation data voltage to each of the plurality of pixels, and provides a sweep data voltage to each of the plurality of sweep circuits; and
a controller which controls the scan driver, the emission driver and the data driver,
wherein each of the plurality of sweep circuits comprises:
a driving transistor including a gate, a first terminal and a second terminal;
a capacitor including a first electrode connected to a power supply voltage line, and a second electrode connected to the gate of the driving transistor;
a first transistor which applies a first reset voltage to a load capacitor connected to a corresponding sweep line among the plurality of sweep lines in response to the first signal;
a second transistor which applies a second reset voltage to the second electrode of the capacitor in response to the first signal;
a third transistor which transfers the sweep data voltage to the first terminal of the driving transistor in response to the second signal;
a fourth transistor which connects the gate and the second terminal of the driving transistor to each other in response to the third signal;
a fifth transistor which connects the first terminal of the driving transistor to the power supply voltage line in response to the emission signal; and
a sixth transistor which connects the second terminal of the driving transistor to the corresponding sweep line in response to the emission signal.

19. The display device of claim 18, wherein each of the plurality of pixels comprises:
a pulse width modulation circuit which generates a pulse width modulation signal based on the pulse width modulation data voltage and a sweep signal applied thereto through the corresponding sweep line;
a constant current generation circuit which generates an emission current based on the constant current generation data voltage and the pulse width modulation signal; and
a light-emitting element which emits light based on the emission current.

20. An electronic device comprising:
a processor which provides input image data; and
a display device which receives the input image data from the processor, and displays an image based on the input image data,
wherein the display device comprises:
a display panel including a plurality of sweep lines and a plurality of pixels connected to the plurality of sweep lines;
a sweep driver including a plurality of sweep circuits respectively connected to the plurality of sweep lines;
a scan driver which provides a scan signal to each of the pixels, and provides a first signal, a second signal and a third signal to each of the plurality of sweep circuits;
an emission driver which provide an emission signal to each of the plurality of pixels and each of the plurality of sweep circuits;
a data driver which provides a pulse width modulation data voltage and a constant current generation data voltage to each of the plurality of pixels, and provides a sweep data voltage to each of the plurality of sweep circuits; and
a controller which controls the scan driver, the emission driver and the data driver,
wherein each of the plurality of sweep circuits comprises:
a driving transistor including a gate, a first terminal and a second terminal;
a capacitor including a first electrode connected to a power supply voltage line, and a second electrode connected to the gate of the driving transistor;
a first transistor which applies a first reset voltage to a load capacitor connected to a corresponding sweep line among the plurality of sweep lines in response to the first signal;
a second transistor which applies a second reset voltage to the second electrode of the capacitor in response to the first signal;
a third transistor which transfers the sweep data voltage to the first terminal of the driving transistor in response to the second signal;
a fourth transistor which connects the gate and the second terminal of the driving transistor to each other in response to the third signal;
a fifth transistor which connects the first terminal of the driving transistor to the power supply voltage line in response to the emission signal; and
a sixth transistor which connects the second terminal of the driving transistor to the corresponding sweep line in response to the emission signal.
